(19) United States
(12) Patent Application Publication
(10) Pub. No.: US 2022/0027327 A1
(43) Pub. Date: Jan. 27, 2022

(54) DISTRIBUTED VFS WITH SHARED PAGE CACHE

(71) Applicant: Huawei Technologies Co., Ltd., Shenzhen (CN)

(72) Inventors: Hao Zhou, Dublin, CA (US); James Park, Foster City, CA (US)

(73) Assignee: Huawei Technologies Co., Ltd., Shenzhen (CN)

(21) Appl. No.: 17/450,486

(22) Filed: Oct. 11, 2021

Related U.S. Application Data
(63) Continuation of application No. PCT/US2019/031782, filed on May 10, 2019.

(51) Int. Cl. G06F 16/188; G06F 16/172; G06F 16/182

(52) U.S. Cl. CPC G06F 16/188; G06F 16/182; G06F 16/172

(57) ABSTRACT

An apparatus includes a memory including a shared page cache and program instructions for a distributed virtual file system (VFS) for use in performing input/output (I/O) operations. An operating system of the computing system executes a central VFS in a first thread and executes a first application and the program instructions for the distributed VFS in a second thread. The distributed VFS determines that a first page, including data to which a first application has requested access, is stored in the shared page cache. In response to the determination, the distributed VFS accesses the requested data from the shared page cache without signaling the operating system or the central VFS. The computing system may be implemented in a device including a microkernel operating system.

### CROSS-REFERENCE TO RELATED APPLICATIONS

This application is a continuation of International Application No. PCT/US2019/031782, filed on May 10, 2019, entitled “DISTRIBUTED VFS WITH SHARED PAGE CACHE,” the benefit of priority of which is claimed herein, and which application is hereby incorporated herein by reference in its entirety.

### TECHNICAL FIELD

A file system for a computing device having limited processing capability is disclosed, and, in particular, a distributed virtual file system (VFS) having a shared page cache memory.

### BACKGROUND

A computing system using a monolithic kernel operating system (OS) includes a file system that is integrated into the OS. The file system implements one or more device drivers for each input/output (I/O) device used by the computing system. Each of these device drivers may have a different source and may need to be modified for a particular OS. Using a device driver from an unreliable source may have detrimental effects on the operation of the OS. In particular, failure of one device driver may seriously impact the performance of the entire OS.

Systems implemented using Microkernel OSs instead of monolithic kernel OSs attempt to mitigate these problems by implementing the file system in user-mode code, outside of the OS. A microkernel OS is an OS that provides minimal functionality, typically only address-space management, thread management and inter-process communication (IPC). A Microkernel OS uses less memory and is less susceptible to failure than a monolithic kernel OS. Because the file system is implemented outside of the OS, failure of a device driver affects only operations related to the corresponding I/O device. Such a failure does not affect the overall operation of the OS.

A microkernel architecture may employ a VFS as a buffer between the operating system and the I/O devices. The VFS may be implemented outside of the OS, in the user code space, insulating the OS from errors in device drivers. The VFS also allows client applications to access different types of I/O devices in a uniform way. For example, the VFS allows client applications to have transparent access to both local and network storage devices. A VFS specifies an interface between the OS and the I/O devices. Using the interface, it is relatively easy to add new file types to the microkernel architecture without modifying the OS. Applications running on a computing system that includes a VFS will perform I/O operations through the OS. Thus, an I/O operation may include sending an I/O request to the OS and waiting for the OS to respond to the request.

In a microkernel architecture, applications invoke Inter-Process Communication (IPC) through the OS to access the VFS and perform I/O operations. To implement IPC, the OS typically performs one or more context switches to switch the computing device between executing the application and executing the file system. An OS performing a context switch stores the state of an executing thread, so that the thread can be restored and executed from the same point at a later time. The OS concurrently restores the state of another thread to execute the other thread from its stop point. In this example, the OS stores the state of the executing application and restores the state of the VFS to perform the requested I/O operation. When the I/O operation is complete, the OS stores the state of the VFS and restores the state of the executing thread that requested the I/O operation. When performing a context switch, the OS stores and retrieves data structures used by the application and the VFS. Data structures maintained by the OS are not affected by the context switch as both the application and the VFS operate under control of the OS and use the data structures maintained by the OS. The one or more extra IPC operations used to perform the I/O operations may have a detrimental effect on the overall operation of applications running on the computing device by increasing the time required to perform the I/O operations.

### SUMMARY

A computing device includes a distributed virtual file system (VFS) that interacts with a central VFS through a shared page cache. The distributed VFS may be implemented as a program library that may be accessed by applications running in the user-space of the computing device. The central VFS interfaces with the OS and performs all of the functions of a conventional VFS. In addition, the central VFS interfaces with a shared page cache. The shared page cache is an area in shared memory that may be accessed by both the central VFS and by applications, through the distributed VFS. The shared page cache holds page data from various I/O devices accessed by the applications and, thus, by the distributed VFS. Each application accesses the program library containing the distributed VFS. The distributed VFS directly interfaces with the OS, the applications, and the shared page cache. When the pages to be accessed by the applications are in the shared page cache, the application may perform I/O operations on the pages without sending an I/O request to the OS. When the requested pages are not in the shared page cache, the distributed VFS sends I/O requests to the OS, which are then handled by the central VFS. Using the distributed VFS, the application can access data that is in the shared page cache without involving the operating system or the central VFS. This results in improved performance of computing devices that use a VFS, because applications can access data from the shared page cache without the overhead of operating system function calls and/or communication protocols between the applications and the VFS. For embodiments in devices that employ microkernel operating systems to reduce memory usage, applications employ inter-process communication (IPC) to interface with the VFS which is implemented in the user space, outside of the operating system. The use of IPC in these environments involves at least one context switch. Performing I/O operations without the context switch represents a significant reduction in the time used to perform the I/O operation.

These examples are encompassed by the features of the independent claims. Further embodiments are apparent from the dependent claims, the description and the figures.

According to a first aspect, a computing device includes a memory including a shared page cache and program instructions for a distributed virtual file system (VFS). A processor, coupled to the memory, is configured by an operating system to execute a central VFS in a first thread and to execute a first application and the program instructions for the distributed VFS in a second thread. The processor running the distributed VFS is configured to receive a first request from the first application to access file data from a first page and determine that the first page is in the shared page cache. Upon determining that the first page is in the shared page cache, the processor running the distributed VFS is configured to access file data from a first page in the shared page cache.

In a first implementation form of the device according to the first aspect as such, the processor executing the distributed VFS is configured to receive, as the first request, a request to write first data to the first page. The processor executing the distributed VFS is further configured to determine that the first page in the shared page cache is marked for exclusive use by the first application and to write first data to the first page in the shared page cache.

In a second implementation form of the device according to the first aspect as such, the processor executing the distributed VFS is configured to receive, as the first request, a request to read first data from the first page. The processor executing the distributed VFS is further configured to determine that the first page in the shared page cache is marked for shared use and to read the first data from the first page in the shared page cache.

In a third implementation form of the device according to the first aspect as such, the processor executing the distributed VFS is configured to receive, from the first application, a second request to write second data to the first page. The processor executing the distributed VFS is further configured to signal the central VFS to mark the first page for exclusive use by the first application. In response to receiving further signaling from the central VFS indicating that the first page is marked for exclusive use by the first application, the processor executing the distributed VFS is configured to write the second data to the first page in the shared page cache.

In a fourth implementation form of the device according to the first aspect as such, the processor executing the central VFS is configured to receive signaling from the distributed VFS to mark the first page for exclusive use by the first application and to complete any pending data access requests to the first page by a second application. The processor executing the central VFS is further configured to mark the first page for exclusive use by the first application and to signal the distributed VFS that the first page in the shared page cache is marked for exclusive use by the first application.

In a fifth implementation form of the device according to the first aspect as such, the processor executing the distributed VFS is configured to receive, from the first application, a second request to read second data from a second page and to determine that the second page is in the shared page cache and is marked for exclusive use by a second application. The processor executing the distributed VFS is further configured to signal the central VFS to mark the second page for shared use and, in response to receiving further signaling from the central VFS indicating that the second page is marked for shared use, to read the second data from the second page in the shared page cache.

In a sixth implementation form of the device according to the first aspect as such, the processor executing the central VFS is configured to receive the signaling from the distributed VFS to mark the second page for shared use. The processor executing the central VFS is further configured to determine that all pending write requests from the second application to write data to the second page in the shared page cache have been completed and to send the further signaling to the distributed VFS, the further signaling indicating that the second page is marked for shared use.

In a seventh implementation form of the device according to the first aspect as such, the processor executing the distributed VFS is configured to receive a request from the first application to access second file data from a second page and to determine that the second page is not in the shared page cache. The processor executing the distributed VFS is further configured to signal the central VFS to copy the second page into the shared page cache and, responsive to receiving signaling from the central VFS indicating that the second page is in the shared page cache, to access the second file data from the second page in the shared page cache.

In an eighth implementation form of the device according to the first aspect as such, the processor executing the central VFS is configured to receive the signaling from the distributed VFS to copy the second page into the shared page cache and, in response to the signaling, to fetch the second page from a media device coupled to the computing device. The processor executing the central VFS is further configured to store the second page in the shared page cache and to signal the distributed VFS that the second page is in the shared page cache.

In a ninth implementation form of the device according to the first aspect as such, the processor executing the distributed VFS is configured to send a first input/output (I/O) request requesting second file data to the central VFS via the operating system, the first I/O request being sent in a command ring buffer and to receive an I/O response from the central VFS in the command ring buffer. Upon receiving the response, the processor executing the distributed VFS is configured to access the requested second file data from a ring data buffer.

In a tenth implementation form of the device according to the first aspect as such, the processor executing the central VFS is configured to receive the first I/O request in the command ring buffer and to fetch the requested second file data from a media device coupled to the computing device. The processor executing the central VFS is further configured to store the requested second file data in the ring data buffer and to send the I/O response in the command ring buffer to the distributed VFS.

According to a second aspect, a method for performing input/output (I/O) operations in a computing device reads a first page from a media device via a central virtual file system (VFS) executing in a first thread and stores the first page into a shared page cache memory. The method receives, via a distributed VFS executing in a second thread, a first request from a first application executing in the second thread to access the first page. Upon determining, by the distributed VFS, that the first page is in the shared page cache memory, the method accesses the first page from the shared page cache memory using the distributed VFS.

In a first implementation form of the method according to the second aspect as such, the method includes determining, by the distributed VFS, that the first page is marked for exclusive use by the first application. The method further includes the distributed VFS receiving, as the first request, a request to write the first data to the first page and writing the first data into the first page in the shared page cache.

In a second implementation form of the method according to the second aspect as such, the method includes determining, by the distributed VFS, that the first page is marked for shared use. The method further includes the distributed VFS receiving, as the first request, a request to read the first data from the first page and reading first data from the first page in the shared page cache.

In a third implementation form of the method according to the second aspect as such, the method includes receiving, by the distributed VFS, a second request from the first application to write second data to the first page. In response to the second request, the method includes the distributed VFS signaling the central VFS, by the distributed VFS, to mark the first page for exclusive use by the first application and, in response to receiving further signaling from the central VFS indicating that the first page is marked for exclusive use by the first application, writing the second data to the first page in the shared page cache memory.

In a fourth implementation form of the method according to the second aspect as such, the method includes receiving, by the central VFS, the signaling from the distributed VFS to mark the first page for exclusive use by the first application and completing any pending data access requests to the first page by a second application. The method further includes the central VFS marking the first page for exclusive use by the first application and sending the further signaling to the distributed VFS.

In a fifth implementation form of the method according to the second aspect as such, the method includes receiving, by the distributed VFS and from the first application, a second request to read second data from a second page. The method further includes the distributed VFS determining that the second page is in the shared page cache memory and is marked for exclusive use of a second application and signaling the central VFS to mark the second page for shared use. In response to receiving further signaling from the central VFS indicating that the second page is marked for shared use, the method includes the distributed VFS reading the second data from the second page in the shared page cache memory.

In a sixth implementation form of the method according to the second aspect as such, the method includes receiving, by the central VFS, the signaling from the distributed VFS to mark the second page for shared use. The method further includes the central VFS determining that all pending write requests from the second application to write data to the second page in the shared page cache memory have been completed and sending the further signaling to the distributed VFS.

In a seventh implementation form of the method according to the second aspect as such, the method includes the distributed VFS sending the first signaling to the central VFS. The sending further includes sending a first I/O request via an inter-process communication (IPC) operation. The first I/O request is sent to the central VFS in a command ring buffer. The distributed VFS places the first signaling into the command ring buffer and the central VFS retrieves the first signaling from the command ring buffer. The method also includes the distributed VFS receiving the second signaling from the central VFS. The receiving the second signaling includes receiving an I/O response from the central VFS in the command ring buffer. The central VFS places the I/O response in the command ring buffer and the distributed VFS retrieves the I/O response from the command ring buffer.

According to a third aspect, a computing device configured to perform I/O operations for data on a media device includes means for reading a first page from a media device and means for storing the first page into a shared page cache memory. The apparatus further includes means for receiving a first request to access the first page, means for determining that the first page is in the shared page cache memory, and means for accessing the first page from the shared page cache memory.

According to a fourth aspect, a non-transitory computer readable medium stores instructions that, when executed by one or more processors, cause the one or more processors to read a first page from a media device via a central virtual file system (VFS) executing in a first thread and stores the first page into a shared page cache memory. The instructions further cause the one or more processors to receive, via a distributed VFS executing in a second thread, a first request from a first application, executing in the second thread, to access the first page. Upon determining, by the distributed VFS, that the first page is in the shared page cache memory, the instructions cause the one or more processors to access the first page from the shared page cache memory using the distributed VFS.

### BRIEF DESCRIPTION OF THE DRAWINGS

FIG. 1 is a block diagram of a microkernel architecture including a distributed VFS according to an example embodiment.

FIG. 2 is a block diagram showing VFS data structures and data access according to an example embodiment.

FIG. 3 is a flowchart illustrating a method performed by a distributed VFS according to an example embodiment.

FIG. 4 is a flowchart illustrating a method performed by a distributed VFS according to an example embodiment.

FIG. 5 is a block diagram of a computing device for implementing a VFS according to an example embodiment.

### DETAILED DESCRIPTION

In the following description, reference is made to the accompanying drawings that form a part hereof, and in which are shown by way of illustration specific embodiments which may be practiced. These embodiments are described in sufficient detail to enable those skilled in the art to practice the disclosed subject matter, and it is to be understood that other embodiments may be utilized, and that structural, logical and electrical changes may be made without departing from the scope of the appended claims. The following description of example embodiments is, therefore, not to be taken in a limited sense.

One way to improve the performance of a system including a microkernel OS is to implement a distributed Virtual File System (VFS). A VFS includes a page cache pool in memory that caches pages which are accessed by the computing system so that the file system does not need to access the physical medium for each I/O operation. A microkernel OS (having a distributed VFS) stores pages retrieved from the relevant I/O devices in the page cache pool so that I/O operations on the pages may be performed using the cached page, without incurring the delays inherent in accessing the physical medium. The VFS writes a page back to the physical medium when another computing device attempts to access data on the page or when the page cache pool is full and an application on the computing device needs to access a page that is not currently in the pool. Similarly, the VFS reads a page from the physical medium and stores the page in the page cache pool when a page accessed by an application on the computing device is not currently in the page cache pool.

As described above, however, when the computing device uses a microkernel OS, applications running on the computing device use Inter-Process Communication (IPC) signaling to request access to the data from the VFS. The IPC operations may add undesirable delays to I/O operations.

Example embodiments implement a distributed VFS which includes a page cache pool in shared memory, a central VFS that handles all physical media and has access to the page cache pool in shared memory, and local VFSs which may be implemented, for example, as a VFS library that is accessed by each application. The local VFSs also have access to the page cache pool in the shared memory. For many I/O operations, the local VFSs can access the page cache pool in shared memory without using IPC signaling, without incurring the overhead of invoking IPC and the context switching inherent in the IPC operation.

Context switches may have different amounts of overhead, depending on whether the computing device is a single core or multi-core processor. In a multicore processor, the OS may run in a first thread on one core, and each application in other threads in other cores, while the central VFS may run in another thread on a yet another core. Each of these programs may have exclusive access to local memory, and all of the programs may have access to a shared memory. In example embodiments, each thread may or may not execute on a separate processor. In a single core environment, only one thread may execute at a time. Context switching from one thread to another may entail storing the state of the currently executing thread and restoring the state of the next thread to be executed.

A system using a multi-core processor may not store and restore program states, and thus may have less overhead than a system using a single-core processor. Whether the system uses a single-core processor or a multi-core processor, the system uses a communication method in the shared memory to switch among the executing threads. One such communication method is via a circular buffer or ring buffer, maintained by the microkernel OS. The ring buffer is a circular data structure which is cyclically addressed such that the most recently written data overwrites the oldest data in the buffer. In this instance, the ring buffer holds commands during context switches between the application accessing the local VFS and the central VFS. Because this command ring buffer is maintained by the microkernel OS, the ring buffer is not affected by the context switch. In an example embodiment, a command ring buffer includes a write pointer pointing to a location in the buffer into which one thread (for example, a local VFS of an application) may write a command. The command ring buffer further includes a read pointer pointing to a location in the buffer from which another thread (for example, the central VFS) may read a command In an IPC operation, a local VFS may write an I/O request into the command ring buffer and perform a context switch to suspend execution of the application containing the local VFS and resume execution of the central VFS. The central VFS reads the command from the command ring buffer and performs the requested I/O operation. As used herein, the distributed VFS sends the command to the central VFS using the command ring buffer (or could be viewed as “passing” the command, wherein the distributed VFS places the command in the command ring buffer for the central VFS to retrieve). The central VFS informs the application that the I/O operation is complete by placing the result of the I/O operation in the command ring buffer before initiating a context switch for the OS to resume executing the application. The local VFS may then resume its operation and read the result from the command ring buffer or from a location in the shared memory pointed to by the result from the command ring buffer.

A similar ring buffer technique, using a ring data buffer in the shared memory, may be used to exchange data between or among threads. The ring data buffer and the command ring buffer may be coordinated such that the command in the command ring buffer indicates a location in the ring data buffer for data being transferred. The IPC operation described above is one example. Other signaling techniques, such as interrupt-driven and event-driven systems, may be used to communicate among the microkernel OS and other applications in the program space, including applications implementing local VFSs and a central VFS.

As described below, the example distributed VFS system may still use IPC signaling for some I/O operations, such as accessing file data that is not in the shared page cache pool or accessing data in a cached page that is marked as exclusive to another application. Many other I/O applications, however, can be implemented using the distributed VFS by accessing pages in the shared page cache pool without involving the OS. This results in improved performance of computing devices having a microkernel OS, with the distributed VFS relative to microkernel OS devices using a centralized VFS without affecting other advantages of the microkernel architecture such as the ability to isolate the OS from device driver errors.

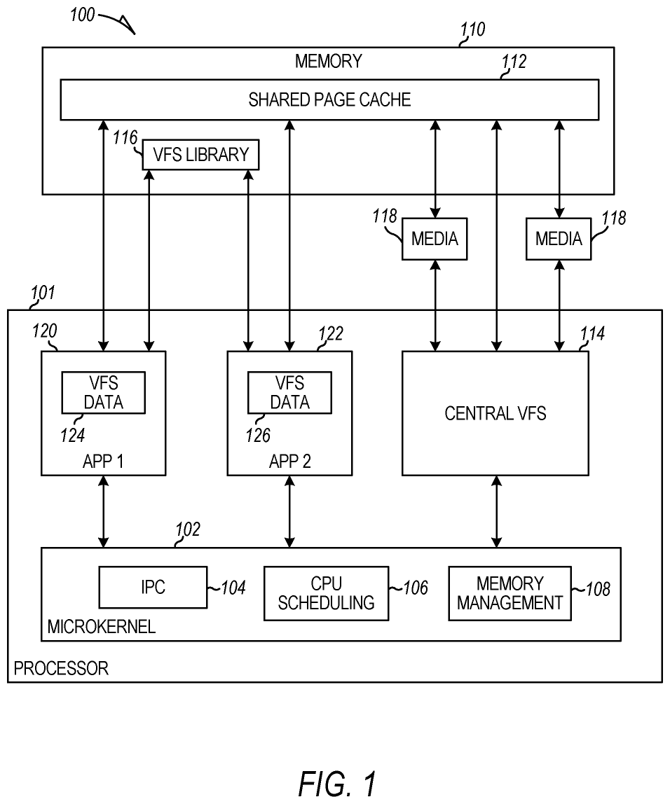

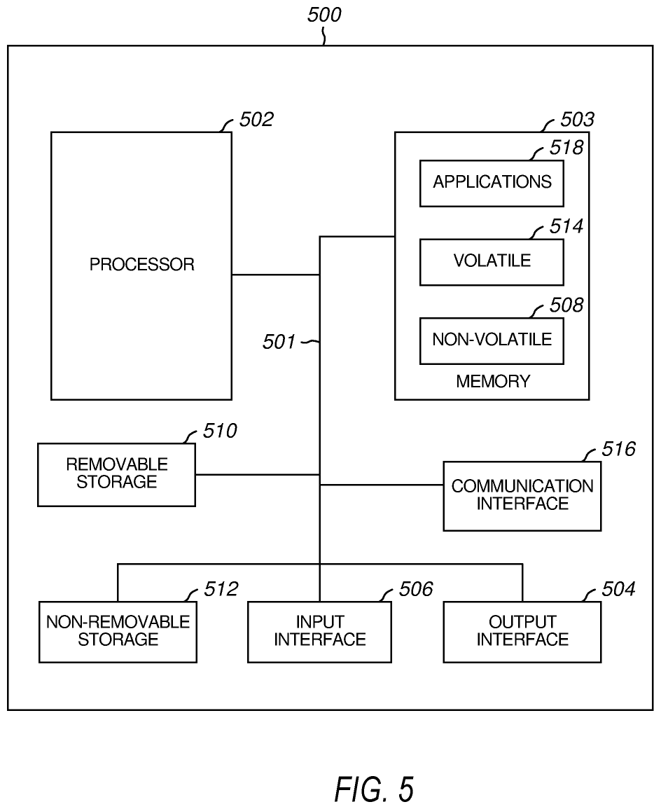

FIG. 1 is a block diagram of a computing device 100 including a microkernel architecture having a distributed virtual file system (VFS) according to an example embodiment. The computing device 100 may be implemented on a device such as the computing device 500 described below with reference to FIG. 5. The example computing device 100 shown in FIG. 1 includes a processor 101 and a memory 110. The processor 101 and the memory 110 can be co-located, or can be separate devices in communication with each other. The processor 101 executes a microkernel OS 102, a central VFS 114, and applications 120 and 122, for example. It should be understood that different numbers of applications can be executed by the processor 101. The microkernel OS 102 has limited functions compared to a monolithic OS. The example microkernel OS 102 includes IPC code 104 which handles IPC operations, CPU scheduling code 106 which handles context switching and application execution, and memory management code 108 which manages memory access by the OS 102, by the applications 120 and 122, and by the central VFS 114. The computing device 100 also includes a shared page cache pool 112 in the memory 110.

The memory 110 includes the shared page cache pool 112 and also includes a VFS library 116, including VFS program instructions (code) to which applications 120 and 122 have access for implementing the example distributed VFS. The VFS library 116 may be, for example, a Dynamic Shared Object (DSO), a virtual DSO (vDSO), a dynamic-link library (DLL), a Library (LIB), or a dynamic library (DYLIB).

Application 120 is coupled to (or in communication with) the microkernel OS 102 and, via a first instance of the VFS library 116, to the shared page cache pool 112. Similarly, application 122 is coupled to (or in communication with) the microkernel OS 102 and, via a second instance of the VFS library 116, to the shared page cache pool 112. Application 120 includes local VFS data structure 124 for the first instance of the VFS library 116 and application 122 includes local VFS data structure 126 for the second instance of the VFS library 116. As described below, the local VFS data structures 124 and 126 include data used by the local VFS to access file data in the shared page cache pool 112 and to implement I/O requests to the central VFS 114 for file data that the local VFS cannot access from the shared page cache pool 112. Although not shown, the memory 110 in the example embodiment also includes instructions for the microkernel OS 102, for the applications 120 and 122, and for the central VFS 114.

The central VFS 114 is configured with access to the shared page cache pool 112, the microkernel OS 102, and the media devices 118. The media devices 118 are configured with access to the shared page cache pool 112, for example, for performing direct memory access (DMA) transfers of pages of data between the media devices 118 and the shared page cache pool 112, under control of the central VFS 114.

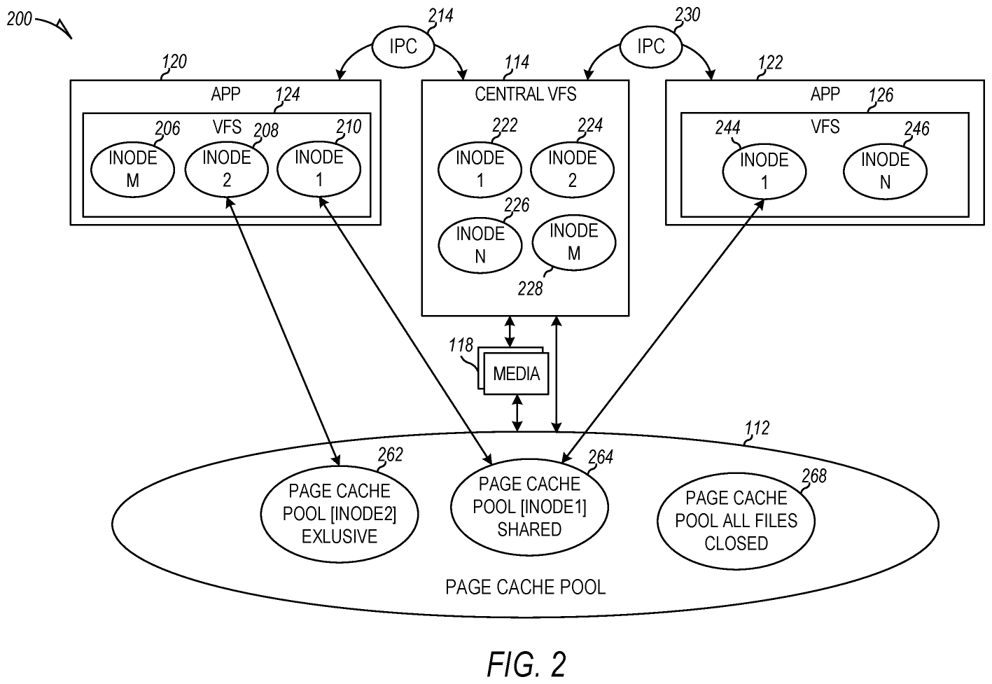

FIG. 2 is a block diagram showing VFS data structures and data access according to an example embodiment. The data structures 200 shown in FIG. 2 include the shared page cache pool 112 and Mode data structures in central VFS 114 and applications 120 and 122. As shown in FIG. 1, application 120 includes the local VFS data structure 124 and application 122 includes the local VFS data structure 126. The central VFS 114 is configured with access to the media devices 118 and to the shared page cache pool 112. The media devices 118, as described above, also have access to the shared page cache pool 112 to send page data to and/or receive page data from the shared page cache pool 112, under control of the central VFS 114. Application 120 sends I/O commands to and receives I/O results from central VFS 114 via IPC signaling 214. Application 122 sends I/O commands to and receives I/O results from central VFS 114 via IPC signaling 230. Although the signaling paths for IPC signaling 214 and 230 are shown in FIG. 2 as being between the applications 120 and 122 on the one hand and the central VFS 114 on the other hand, the actual signaling path is through the IPC code 104 of the microkernel OS 102 shown in FIG. 1

The inode data structures in the distributed VFS, in each of the applications 120 and 122 and in the central VFS 114, correspond to the respective files accessed by the applications 120 and 122 and the central VFS 114. For example, the local VFS data structure 124 in application 120 includes respective copies 206, 208, and 210 of inode M, inode 1, and inode 2, and the local VFS data structure 126 in application 122 includes respective copies 244 and 246 of inode 1 and inode N.

Each inode corresponds to a directory or file, which may include one or more pages, and stores metadata about those pages. The metadata may include a unique identifier, a storage location, access rights, owner identifier, and/or other fields. The inodes for the various files/directories may be stored in the media devices 118 (e.g., a disk device) along with file data and/or page data. To access a page of a file, the central VFS 114 locates the inode for the file on the media device 118, reads the metadata for the requested page into the shared page cache pool 112 or into memory local to the central VFS 114, and then uses the metadata to locate and read data from and/or write data to the page on the media device 118. The central VFS 114 may store the inode data structures in the shared page cache pool 112 so that they may be accessed directly by the central VFS 114 and each of the distributed VFS data structures 124 and 126. As these accesses do not use IPC signaling, storing the inode data structures in the shared page cache pool 112 may reduce the time to access the page metadata. In the example embodiment, the inode data structures also include metadata describing the pages in the page cache pool 112. The central VFS 114 includes copies 222, 224, 226 and 228 of Mode 1, Mode 2, Mode N, and Mode M, respectively.

In the example embodiment, Mode N and Mode M contain metadata for small files and/or files that are not frequently accessed and which are accessed only by a single application. The file corresponding to Mode N is accessed only by application 122 and the file corresponding to Mode M is accessed only by application 120. The files corresponding to Mode N and Mode M do not have pages in the shared page cache pool 112. Even using IPC signaling and its inherent context switching, the time spent accessing data from these files may be less than the time used to fetch a page of data into the shared page cache pool 112. Inode 2 (208) contains metadata for a page that is exclusive to application 120, which may both write data to and read data from a page 262 in the shared page cache pool 112. The page 262 is marked as exclusive, meaning that it may only be accessed by one application, here being application 120. Application 120 may both read data from and write data to page 262. As shown in FIG. 2, the page 262 may also include a copy of Mode 2.

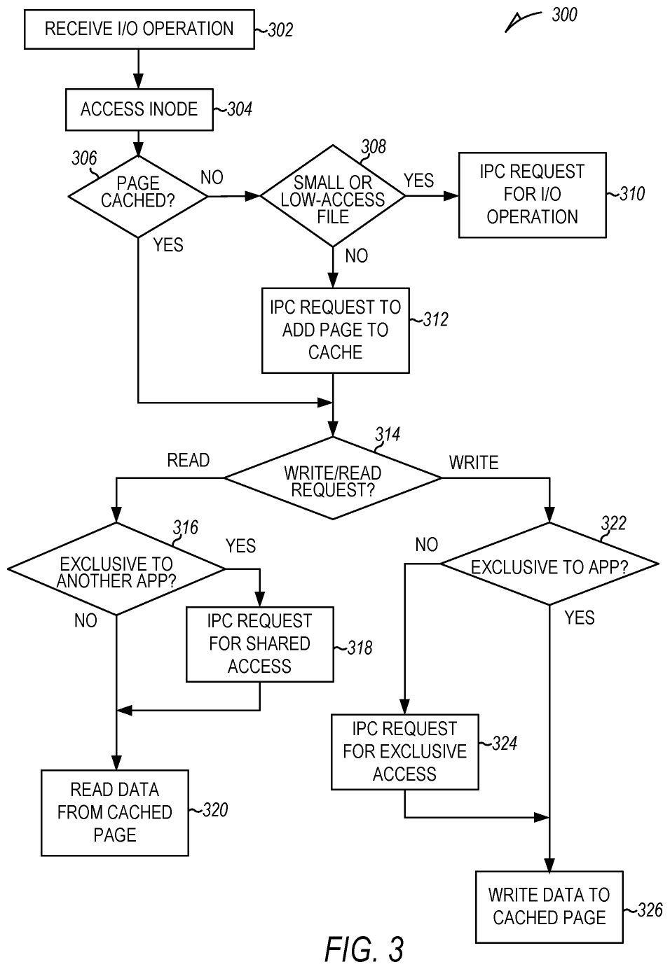

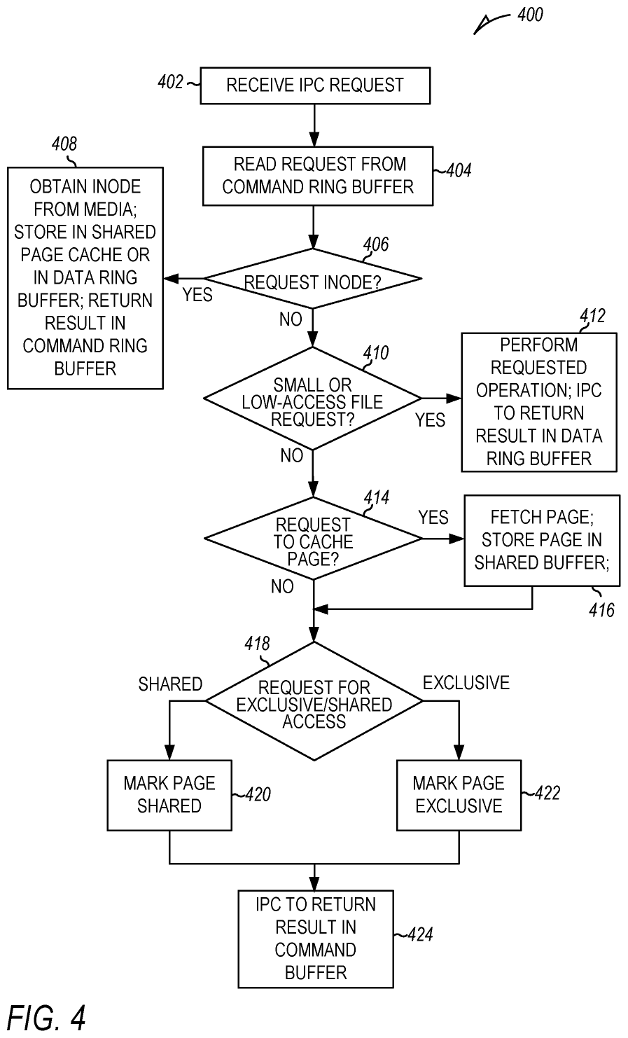

Inode 1 (210, 244) contains metadata for a page 264 in the shared page cache pool 112 that is shared between application 120 and application 122. In the example embodiment, this page 264 is a read-only page. Either application 120 or application 122 may read data from the page 264, but neither application may write data to the page 264. If an application 120 or 122 issues an I/O command to write data to the page 264, the application 120 or 122 first sends an I/O request to the central VFS 114, via an IPC operation. The I/O request the central VFS 114 to change the status of the page 264 to be exclusive to the requesting application. When the central VFS 114 changes a page between exclusive and shared, it updates the Mode for the file containing the page and distributes the updated Mode to the applications that access the page. As described below with reference to FIGS. 3 and 4, if one of the applications 120 or 122 wants to write data to the page 264 corresponding to Mode 1, the application sends an I/O request to the central VFS 114 to change the page type from shared to exclusive. The application 120 or 122 sends this I/O request via an IPC operation.

The shared page cache pool 112 may also contain pages 268 for files that were previously accessed by one of the applications 120 and/or 122, but are currently closed. As either application 120 or 122 may reopen these files, the pages 268 of these files are maintained in the shared page cache pool 112 until the shared page cache pool 112 needs the space for other pages. Pages may be maintained in and removed from the shared page cache pool 112 using, for example, a least recently used (LRU) protocol.

FIG. 3 is a flowchart illustrating a method 300 performed by a distributed VFS according to an example embodiment. The method 300 shown in FIG. 3 illustrates the operation of the VFS library code 116, shown in FIG. 1 executing as a part of application 120 or 122. It is contemplated, however, that the method 300 has more general functions for different embodiments of a VFS. The operations described below are performed by the distributed VFS library code 116.

At operation 302, the distributed VFS receives a request for an I/O operation. Operation 304 accesses the Mode for the file containing the page. As shown in FIG. 2, the Mode may be in the local VFS data structure 124 or 126. When the Mode including metadata for the page is not in the local VFS data storage, the operation 304 may send a request to the central VFS 114 to provide the Mode. The central VFS 114 may copy the Mode data structure from the local storage of the VFS 114 or may access the Mode from the media device 118 that includes the requested page. The central VFS 114 may obtain the Mode data structure from the media device 118 as described below with reference to FIG. 4.

After operation 304, operation 306 determines, using the metadata in the Mode, whether the data for the I/O request is in a page in the shared page cache pool 112. When the requested data is not in the shared page cache pool 112, operation 308 determines, from the metadata in the Mode, whether the data is from a small file or from a file that is accessed only infrequently (e.g., a low-access file). Whether a file is a low-access file may be determined from the file type. For example, a display device or keyboard may be accessed relatively infrequently compared to a disk drive. Thus, the display device or keyboard may be classified as a low-access device. Similarly, a keyboard typically provides a relatively small amount of data and may be classified as a small file. The file size information in the Mode may also be used to classify a file as a small file. As described above, small files and infrequently accessed files may not have pages in the shared page cache pool 112. When operation 308 determines that the request is for a small or infrequently accessed file, operation 310 sends an I/O request to the central VFS 114 via an IPC operation. In response to the I/O request, the central VFS 114 obtains the requested data from the media device 118 and provides the requested data to the local VFS as described below with reference to FIG. 4.

When operation 308 determines that the requested data is not from a small or infrequently accessed file, operation 312 uses IPC signaling to request that the central VFS 114 add the page to the shared page cache pool 112. This operation is described below in more detail with reference to FIG. 4. The local VFS may obtain, from the shared page cache pool 112, an updated Mode for the file when the requested page is added to the shared page cache pool 112.

When operation 306 determines that the page is in the shared page cache pool 112 or after operation 312 requests that the central VFS 114 store the page in the shared page cache pool 112, operation 314 determines whether the I/O operation is a read request or a write request. When the operation is a read request, operation 316 determines, from the metadata in the Mode for the file including the page, whether the page is exclusive to another application. When a page is exclusive to an application, only that application may read data from or write data to the page in the shared page cache pool 112. Upon determining that the requested page is exclusive to another application, the method 300, at operation 318, invokes an IPC operation to send an I/O request to the central VFS 114 to change the page to a shared page. This operation is described in more detail below with reference to FIG. 4. The central VFS 114 updates the Mode for the file and stores the updated Mode in the shared page cache pool 112 so that it may be uploaded to the local VFS data structure 124 or 126 in the respective application 120 or 122.

When operation 316 determines that the requested page is a shared page or after the central VFS 114 changes the requested page to a shared page in operation 318, operation 320 reads the data from the cached page and provides the data to the application 120 or 122.

When operation 314 determines that the I/O operation is a write request, operation 322 determines, from the metadata for the page in the Mode for the file, whether the page in the shared page cache pool 112 is exclusive to the requesting application. When the page in the shared page cache pool 112 is not exclusive to the requesting application 120 or 122, operation 324 invokes an IPC operation to send an I/O request to the central VFS 114 to change the page to be exclusive to the application 120 or 122. The central VFS 114 may also update the Mode for the file and store the updated Mode in the shared page cache pool 112 so that it may be uploaded to the local VFS data structure 124 of application 120 or local VFS data structure 126 of application 122. After the page is changed to be exclusive to the application 120 or 122 by operation 324, or after operation 322 determines that the page is exclusive to the application 120 or 122, operation 326 writes the data provided with the I/O operation to the page in the shared page cache pool 112.

FIG. 4 is a flowchart illustrating a method 400 performed by a distributed VFS according to an example embodiment. The method 400 is executed as a part of the central VFS 114 according to an example embodiment. Thus, the operations shown in FIG. 4 are performed by the central VFS. At operation 402, the central VFS 114 receives an I/O request via an IPC operation and, at operation 404, reads the I/O command from the command ring buffer. Operation 406 determines whether the request is to retrieve an Mode for a file. When the request is to retrieve an Mode, operation 408 obtains the Mode metadata from the media device 118 and either stores the Mode data structure in the shared page cache pool 112, in a ring data buffer that may be read by the requesting application, or by other means for returning I/O result data. Operation 408 then signals that the Mode has been obtained by returning a result in the command ring buffer or by other type of inter-process signaling.

When the request is not to retrieve an Mode, at operation 410 the method 400 determines whether the request concerns a small or infrequently accessed file. If the request concerns a small or infrequently accessed file, operation 412 performs the requested operation on the file in the media device 118 and returns the result to the requesting application 120 or 122 in the command ring buffer. As described above, the requested operation may read data from/write data to a ring data buffer or other shared memory, or it may transfer data using a data object transferred between the requesting application 120 or 122 and the central VFS 114.

When the I/O request is not for a small or infrequently accessed page, operation 414 determines whether the request is to store a page into the shared page cache pool 112. If is the request is to store a page into the shared page cache pool 112, then, at operation 416, the central VFS 114 accesses the page from the media device 118 and stores the page into the shared page cache pool 112. As described above, the central VFS 114 may also access the inode for the file containing the page and store it into the shared page cache pool 112 along with the page so that the inode may be uploaded to the local VFS data of the application 120 or 122 that originated the I/O request.

When operation 414 determines that the I/O request was not a request to cache a page, or after the page has been cached by operation 416, operation 418 determines whether the I/O request was for shared or exclusive access. When the request is for shared access, operation 420 marks the page as shared. When the page was already marked as shared by the requesting application 120 or 122, this operation has no effect. When the page is marked as shared but not by the requesting application, information about the requesting application 120 or 122 is added to the inode metadata and the updated inode is uploaded to all of the sharing applications. When the page was marked as exclusive, operation 420 may signal the local VFS of the application 120 or 122 that currently has exclusive access to the page to complete any pending write operations to the page in the shared page cache pool 112 before marking the page as shared. When the status of the page changes from exclusive to shared, the central VFS 114 also updates the inode for the file and uploads the updated inode to all of the applications that are sharing the page.

When operation 418 determines that the request is for exclusive access, operation 422 marks the page as exclusive. If the page was marked as shared, operation 422 updates the inode for the file in the shared page cache pool 112 and notifies the other sharing applications that the page is now exclusive to the requesting application 120 or 122. In response to this notification, each of the other sharing applications may upload the inode for the file from the shared page cache pool 112 or may delete the Mode data structure from the local VFS data of the application. After operation 420 or 422, operation 424 returns a result of the I/O request in the command ring buffer.

FIG. 5 is a block diagram of a computing device 500 for implementing a VFS according to an example embodiment. All components need not be used in various embodiments. For example, the clients, servers, and network resources may each use a different set of components, or in the case of servers, for example, larger storage devices.

One example computing device 500 may include a processor 502, memory 503, removable storage 510, and non-removable storage 512. Although the example computing device is illustrated and described as computing device 500, the computing device may be in different forms in different embodiments. For example, the computing device may instead be a smartphone, a tablet, smartwatch, or other computing device. Devices, such as smartphones, tablets, and smartwatches, are generally collectively referred to as mobile devices or user equipment. Further, although the various data storage elements are illustrated as part of the computing device 500, the removable storage 510 may also or alternatively include cloud-based storage accessible via a network, such as the Internet, or server-based storage.

Memory 503 may include volatile memory 514 and/or non-volatile memory 508. Computing device 500 may include or have access to a computing environment that includes a variety of computer-readable media, such as volatile memory 514, non-volatile memory 508, removable storage 510, and/or non-removable storage 512. Computer storage includes random access memory (RAM), read only memory (ROM), erasable programmable read-only memory (EPROM), electrically erasable programmable read-only memory (EEPROM), flash memory or other memory technologies, compact disc read-only memory (CD ROM), digital versatile disks (DVD) or other optical disk storage, magnetic cassettes, magnetic tape, magnetic disk storage or other magnetic storage devices, or any other medium capable of storing computer-readable instructions.

Computing device 500 may include or have access to a computing environment that includes input interface 506, output interface 504, and a communication interface 516. Output interface 504 may provide an interface to a display device, such as a touchscreen, that also may serve as an input device. The input interface 506 may provide an interface to one or more of a touchscreen, touchpad, mouse, keyboard, camera, one or more device-specific buttons, one or more sensors integrated within or coupled via wired or wireless data connections to the computing device 500, and/or other input devices. The computing device 500 may operate in a networked environment using a communication interface 516 to connect to one or more network nodes or remote computers, such as database servers. The remote computer may include a personal computer (PC), server, router, network PC, a peer device or other common network node, or the like. The communication connection may include a local area network (LAN), a wide area network (WAN), cellular, Wi-Fi, and/or Bluetooth®.

Computer-readable instructions stored on a computer-readable medium are executable by the processor 502 of the computing device 500. Computer-readable instructions may include an application(s) 518 stored in the memory 503. A hard drive, CD-ROM, RAM, and flash memory are some examples of articles including a non-transitory computer-readable medium such as a storage device. The terms computer-readable medium and storage device do not include carrier waves to the extent carrier waves are deemed too transitory.

The functions or algorithms described herein may be implemented using software in one embodiment. The software may consist of computer-executable instructions stored on computer-readable media or computer-readable storage device such as one or more non-transitory memories or other type of hardware-based storage devices, either local or networked, such as in application 518. A device according to embodiments described herein implements software or computer instructions to perform query processing, including DBMS query processing. Further, such functions correspond to modules, which may be software, hardware, firmware or any combination thereof. Multiple functions may be performed in one or more modules as desired, and the embodiments described are merely examples. The software may be executed on a digital signal processor, ASIC, microprocessor, or other type of processor operating on a computer system, such as a personal computer, server or other computer system, turning such computer system into a specifically programmed machine.

A computing device 100 or 500 in some examples comprises a memory 110 or 503 including a shared page cache 112, and program instructions 116 for a distributed VFS. The computing device 100 or 500 including a processor 101 or 502 that is configured by an operating system 102 to execute a central VFS 114 in a first thread and to execute a first application 120 and the distributed VFS in a second thread. The program instructions 116 for the distributed VFS configure the processor 101 to receive a first request from the first application to access file data from a first page. The program instructions 116 further configure the processor to determine that the first page is in the shared page cache 112 and to access the file data from the shared page cache 112 without signaling the central VFS 114.

A computing device 100 or 500 in some examples comprises a means 114 for reading a first page from a media device 118 and for storing the first page into a shared page cache memory 112. The computing device 100 or 500 further includes means 116 for receiving a first request to access the first page and means 116 for determining that the first page is in the shared page cache memory 112. The computing device 100 also includes means 116 for accessing the first page from the shared page cache memory 112.

The computing device 100 or 500 is implemented as the computing device 500 in some embodiments. The computing device 100 or 500 is implemented as a device having a microkernel operating system 102.

Although a few embodiments have been described in detail above, other modifications are possible. For example, the logic flows depicted in the figures do not require the particular order shown, or sequential order, to achieve desirable results. Other steps may be provided, or steps may be eliminated, from the described flows, and other components may be added to, or removed from, the described systems. Other embodiments may be within the scope of the following claims.

What is claimed is:

1. An apparatus for performing input/output (I/O) operations in a computing device, the apparatus comprising:
a memory including a shared page cache and program instructions for a distributed virtual file system (VFS); and
a processor, coupled to the memory, wherein the processor is configured to execute a central VFS in a first thread and to execute a first application and the program instructions for the distributed VFS in a second thread, the distributed VFS program instructions configuring the processor to:
receive a first request from the first application to access file data from a first page;
determine that the first page is in the shared page cache; and
access the file data from the first page in the shared page cache.

2. The apparatus of claim 1, wherein the distributed VFS program instructions further configure the processor to:
receive, as the first request, a request to write first data to the first page;
determine that the first page in the shared page cache is marked for exclusive use by the first application; and
write the first data to the first page in the shared page cache.

3. The apparatus of claim 1, wherein the distributed VFS program instructions configure the processor to:
receive, as the first request, a request to read first data from the first page;
determine that the first page in the shared page cache is marked for shared use; and
read the first data from the first page in the shared page cache.

4. The apparatus of claim 3, wherein the distributed VFS program instructions further configure the processor to:
receive, from the first application, a second request to write second data to the first page;
send first signaling to the central VFS to mark the first page for exclusive use by the first application; and
write the second data to the first page in the shared page cache in response to receiving second signaling from the central VFS, the second signaling indicating that the first page is marked for exclusive use by the first application.

5. The apparatus of claim 4, wherein the central VFS configures the processor to:
receive the first signaling from the distributed VFS to mark the first page for exclusive use by the first application;
complete any pending data access requests to the first page by a second application;
mark the first page for exclusive use by the first application; and
send the second signaling to the distributed VFS, the second signaling indicating that the first page in the shared page cache is marked for exclusive use by the first application.

6. The apparatus of claim 1, wherein the distributed VFS program instructions configure the processor to:
receive, from the first application, a second request to read second data from a second page;
determine that the second page is in the shared page cache and is marked for exclusive use by a second application;
send first signaling to mark the second page for shared use to the central VFS; and
read the second data from the second page in the shared page cache in response to receiving second signaling from the central VFS, the second signaling indicating that the second page is marked for shared use.

7. The apparatus of claim 6, wherein the central VFS configures the processor to:
receive the first signaling from the distributed VFS to mark the second page for shared use;
determine that all pending write requests from the second application to write data to the second page in the shared page cache have been completed; and
send the second signaling to the distributed VFS, the second signaling indicating that the second page is marked for shared use.

8. The apparatus of claim 1, wherein the distributed VFS program instructions configure the processor to:
receive a request from the first application to access second file data from a second page;
determine that the second page is not in the shared page cache;
send first signaling to the central VFS to copy the second page into the shared page cache; and
access the second file data from the second page in the shared page cache responsive to receiving second signaling from the central VFS, the second signaling indicating that the second page is in the shared page cache.

9. The apparatus of claim 8, wherein the central VFS configures the processor to:
receive the first signaling from the distributed VFS to copy the second page into the shared page cache;
fetch the second page from a media device coupled to the apparatus;
store the second page in the shared page cache; and
send the second signaling to the distributed VFS, the second signaling indicating that the second page is in the shared page cache.

10. The apparatus of claim 1, wherein the distributed VFS program instructions configure the processor to:
send a first I/O request via an inter-process communication (IPC) operation to the central VFS via the operating system, the first I/O request requesting second file data, the first I/O request being sent in a command ring buffer;
receive an I/O response in the command ring buffer; and
access the requested second file data from a ring data buffer.

11. The apparatus of claim 10, wherein the central VFS configures the processor to:
receive the first I/O request in the command ring buffer;
fetch the requested second file data from a media device coupled to the apparatus;
store the requested second file data in the ring data buffer; and
send the I/O response in the command ring buffer to the distributed VFS.

12. A method for performing input/output (I/O) operations in a computing device, the method comprising:
reading a first page from a media device via a central virtual file system (VFS) executing in a first thread;
storing, by the central VFS, the first page into a shared page cache memory;
receiving, by a distributed VFS executing in a second thread, a first request from a first application executing in the second thread, the first request comprising a request to access the first page;
determining, by the distributed VFS, that the first page is in the shared page cache memory; and
accessing, by the distributed VFS, the first page from the shared page cache memory.

13. The method of claim 12, further comprising:
determining, by the distributed VFS, that the first page is marked for exclusive use by the first application;
receiving, by the distributed VFS as the first request, a request to write the file data to the first page; and
writing, by the distributed VFS, the file data into the first page in the shared page cache memory.

14. The method of claim 12, further comprising:
determining, by the distributed VFS, that the first page is marked for shared use;
receiving, by the distributed VFS as the first request, a request to read the file data from the first page; and
reading, by the distributed VFS, the file data from the first page in the shared page cache memory.

15. The method of claim 14, further comprising:
receiving, by the distributed VFS, a second request from the first application to write second data to the first page;
sending, by the distributed VFS to the central VFS, first signaling to mark the first page for exclusive use by the first application; and
writing the second data, by the distributed VFS to the first page in the shared page cache memory, in response to the distributed VFS receiving second signaling from the central VFS, the second signaling indicating that the first page is marked for exclusive use by the first application.

16. The method of claim 15, further comprising:
receiving, by the central VFS, the second signaling from the distributed VFS to mark the first page for exclusive use by the first application;
completing, by the central VFS, any pending data access requests to the first page by a second application;
marking, by the central VFS, the first page for exclusive use by the first application; and
sending, by the central VFS, the second signaling to the distributed VFS.

17. The method of claim 12, further comprising:
receiving, by the distributed VFS from the first application, a second request to read second data from a second page;
determining, by the distributed VFS, that the second page in the shared page cache memory is marked for exclusive use of a second application;
sending, by the distributed VFS to the central VFS, first signaling to mark the second page for shared use; and
reading, by the distributed VFS, the second data from the second page in the shared page cache memory in response to the distributed VFS receiving second signaling from the central VFS, the second signaling indicating that the second page is marked for shared use.

18. The method of claim 17, further comprising:
receiving, by the central VFS from the distributed VFS, the first signaling to mark the second page for shared use;
determining, by the central VFS, that all pending write requests from the second application to write data to the second page in the shared page cache memory have been completed; and
sending, by the central VFS to the distributed VFS, the second signaling.

19. The method of claim 17, wherein:
the sending of the first signaling by the distributed VFS to the central VFS includes sending a first I/O request via an inter-process communication (IPC) operation, the first I/O request being sent in a command ring buffer; and
the receiving of the second signaling, by the distributed VFS from the central VFS, includes receiving an I/O response in the command ring buffer.

20. An apparatus for use in a computing device to perform input/output (I/O) operations, the apparatus comprising:
means for reading a first page from a media device;
means for storing the first page into a shared page cache memory;
means for receiving a first request to access the first page;
means for determining that the first page is in the shared page cache memory; and
means for accessing the first page from the shared page cache memory.
